(19) United States
(12) Patent Application Publication
(10) Pub. No.: US 2021/0093984 A1
(43) Pub. Date: Apr. 1, 2021

(54) SOLIDS SEPARATION AND RECOVERY SYSTEM

(71) Applicant: Belton Energy Services Ltd., Calgary, CA (US)

(72) Inventor: Timothy Macartney, Calgary (CA)

(21) Appl. No.: 16/585,377

(22) Filed: Sep. 27, 2019

(51) Int. Cl. B01D 17/02; B01D 21/02; B01D 21/26

(52) U.S. Cl. CPC B01D 17/0205; B01D 21/02; B01D 2221/04; B01D 17/0217; B01D 21/262

(57) ABSTRACT

A separator is provided for removing hydrocarbons and fluid from solids from a slurry. The separator includes a first separator tank for receiving a slurry of fluid and solids contaminated with hydrocarbons, said first separator tank comprising agitating means for agitating hydrocarbons to separate from the slurry and rise as foam and comprising a lower end to collect the solids; a first centrifuge in communication with the lower end of the first separator tank to receive and centrifuge the solids to further remove hydrocarbons therefrom, said first centrifuge comprising a fluid return to return fluids to the first separator tank; a second separator tank for receiving solids from the first centrifuge, said second separator tank comprising agitator means for agitating hydrocarbons to separate from the slurry and rise as foam and comprising a lower end to collect solids; a second centrifuge in communication with the lower end of the second separator tank to receive and centrifuge the solids to further remove hydrocarbons therefrom, said second centrifuge comprising a fluid return to return fluids to the second separator tank; and one or more settling tanks connected in series with each of said first and second separator tanks for further separation of hydrocarbons from fluid. Solids exiting the first and second centrifuges are at least 99% free of hydrocarbons.

### FIELD

The present disclosure relates to a separator for separating a used drilling slurry, removing liquid hydrocarbons from the drilling solids, and providing a reusable drilling fluid stream.

### BACKGROUND

Drilling fluids are used during a drilling operation to cool a drill bit and to flush out the drill cuttings. In hydrocarbon wells, the most common drilling fluids are water-based or hydrocarbon-based. When drilling a hydrocarbon-producing well, the cuttings will often be oily cuttings. A shale shaker is used to remove some of the liquid from the cuttings, but the result is a slurry of cuttings, liquid hydrocarbons and drilling fluid that must be disposed of. U.S. Pat. No. 5,093,008 (Clifford, Ill.) entitled “Process and apparatus for recovering reusable water from waste drilling fluid” describes how water may be recovered from the drilling fluid.

Applicant's Canadian patent no. 2,694,811 teaches a system of tanks and valves presenting a multitude of configurations for providing a reusable drill fluid, separating solids from drilling fluid and providing a clean recirculating fluid back to the system.

Environmental regulations such as, for example Alberta Energy Regulator Directive 050 dictate that solids drilling waste (i.e., solids) must be essentially hydrocarbon free in order to be disposed of by landspreading. While technology exists, such as Applicant's previous patent, to clean the drilling fluids of drill solids, the drilling solids waste is often still significantly contaminated with hydrocarbons from the drilling operation.

Contaminated drilling solids waste is expensive to dispose of and a challenge to sufficiently clean to meet landspreading and other purposes.

A need therefore exists in the art for a dedicated system for cleaning drilling solids wastes of hydrocarbon residue, to form a non-contaminated solids product.

### SUMMARY

A separator is provided for removing hydrocarbons and fluid from solids from a slurry, the separator comprising:
a. a first separator tank for receiving a slurry of fluid and solids contaminated with hydrocarbons, said first separator tank comprising agitating means for agitating hydrocarbons to separate from the slurry and rise as foam and comprising a lower end to collect the solids;
b. a first centrifuge in communication with the lower end of the first separator tank to receive and centrifuge the solids to further remove hydrocarbons therefrom, said first centrifuge comprising a solids outlet, and a fluid return to return fluids to the first separator tank;
c. a second separator tank for receiving solids from the first centrifuge, said second separator tank comprising agitator means for agitating hydrocarbons to separate from the slurry and rise as foam and comprising a lower end to collect solids;
d. a second centrifuge in communication with the lower end of the second separator tank to receive and centrifuge the solids to further remove hydrocarbons therefrom, said second centrifuge comprising a solids outlet, and a fluid return to return fluids to the second separator tank; and
e. one or more settling tanks connected in series with each of said first and second separator tanks for further separation of hydrocarbons from fluid;
   wherein, solids exiting the solids outlets of the first and second centrifuges are at least 99% free of hydrocarbons.

A method is further provided for removing hydrocarbons and fluid from solids from a slurry, the method comprising the steps of:
a. receiving a slurry of fluid and solids contaminated with hydrocarbons a first separator tank, agitating the slurry to separate hydrocarbons from the slurry to rise as foam and allowing solids to settle;
b. receiving solids in a first centrifuge from a lower end of the first separator tank and centrifuging the solids to further remove hydrocarbons therefrom;
c. receiving solids from the first centrifuge into a second separator tank and agitating the solids to separate hydrocarbons from the slurry to rise as foam and allowing solids to settle;
d. receiving solids in a second centrifuge from a lower end of the second separator tank to receive and centrifuge the solids to further remove hydrocarbons therefrom; and
e. transferring fluids from first and second separator tanks into one or more settling tanks connected in series to separate hydrocarbons from the fluid;
   wherein, solids exiting the first and second centrifuges are at least 99% free of hydrocarbons.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top plan view of a separator.

FIG. 2 is a side elevation view of a first set of tanks of the separator; and

FIG. 3 is a side elevation of a second set of tanks of the separator.

### DETAILED DESCRIPTION

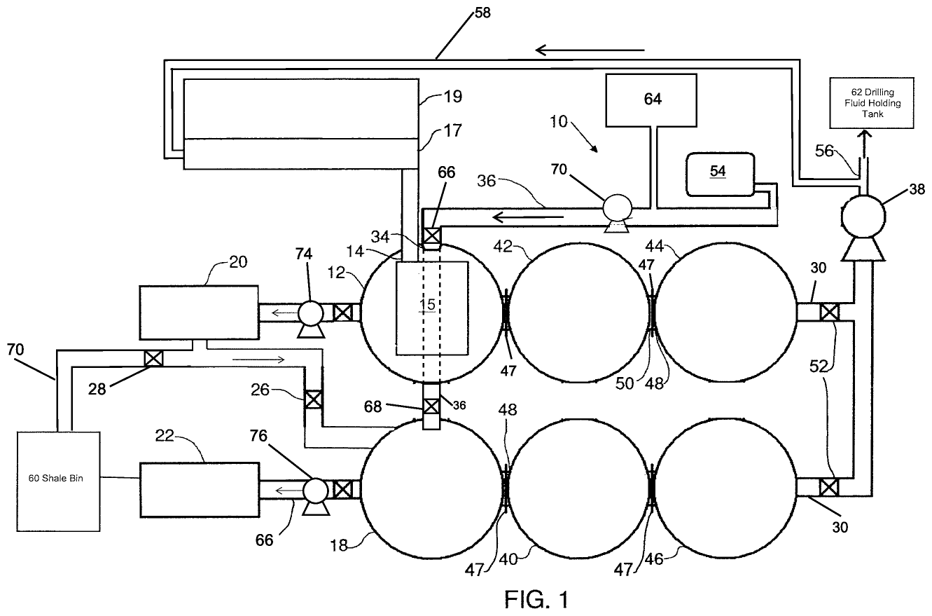

A separator for separating liquid hydrocarbons, solids and fluid from a slurry, such as a drilling fluid used in a drilling operation, generally identified by reference numeral 10, will now be described with reference to FIGS. 1, 2 and 3.

Structure and Relationship of Parts:

Separator 10 is intended to be used in separating the different components in a slurry that contains liquid hydrocarbons, solids, and fluid. For example, separator 10 is useful in separating components in a used drilling fluid, such as water or hydrocarbon based drilling fluids. As the drilling fluids exit a wellbore, there will be cuttings, such as sand or other products from the drilling operation, which may be coated in oil. Oil may also be entrained with the drilling fluid without being coated on the cuttings. Separating the components allows the cuttings to be disposed of more easily and also allows the drilling fluid to be reused. In industry, the drilling fluid is first passed over a standard rig shaker, which generally uses screens and vibration to remove some of the larger cuttings from drilling fluid. Separator 10 described below is preferably located after the rig shaker to receive the fluids after the larger cuttings have been removed.

In the description below, separator 10 is discussed with reference to used drilling fluids. However, it will be understood that separator 10 may be used for other slurrys, such as those that exist in tailings ponds, which are made up of hydrocarbons, suspended solids, and water.

Referring to FIG. 1, separator 10 has a first separator tank 12 that has an inlet 14 for receiving the used drilling fluid and an outlet 16. As shown, inlet 14 is a screen 15 or a shaker over the open top of tank 12, although it may take other forms. Screen 15 is fed from a trough 17 connected to a rig shaker 19. In the depicted embodiment, separator 10 is fed by the solids stream that are output from rig shaker 19, and as such there may be more solids than drilling fluid in the used drilling fluid stream input into separator 10. Screen 15 is used to remove large objects that are easily removed, but may be difficult to process by separator 10. Furthermore, as the solid stream from rig shaker 19 is intended to be treated by separator 10, rig shaker 19 may use a tighter mesh, which keeps out finer solids, but also results in more drilling fluid passing into trough 17.

Solids from a lower end of first separator tank 12 are pumped via pump 74 to a first centrifuge 20 fed that removes at least a portion of the solids from the used drilling fluid and returns the used drilling fluid to first separator tank 12. Solids from the first centrifuge 20 are in this way significantly cleaned of hydrocarbons. If the hydrocarbon content of the solids is sufficiently low, then solids can be fed directly to a shale bin 60 via line 70 and valve 28. In an optional embodiment samples can be taken off of centrifuge 20 at predetermined intervals to determine hydrocarbon content.

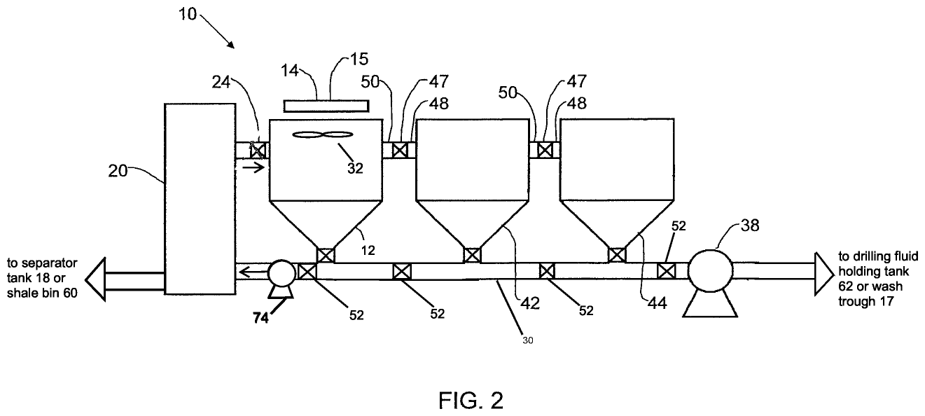

If hydrocarbon content of solids from first centrifuge 20 is higher than a given threshold value, the solids can be fed again via line 70, but this time by valve 26 to a second separator tank 18 and from there to a second centrifuge 22. Referring to FIG. 2, drilling solids in tanks 12 and 18 are preferably drawn off the bottom of the tanks to centrifuges 20 and 22 through a lines 64 and 66 via pumps 74 and 76, as there will generally be a larger concentration of solids toward the bottom.

The Applicants have found that the first centrifuge 20 can create a solid product that is anywhere from 95% to over 99% free of hydrocarbons. Should second centrifuge also be used, hydrocarbon content can be further removed by anywhere from 1% to 5%. As such, the solid product resulting from the present separator 10 system is a dry, clean solids product that can be used for any number of purposes such as agriculture, construction, civic projects and others. The present system takes drilling waste solids, which typically are a cost to dispose of, and cleans them into a saleable product.

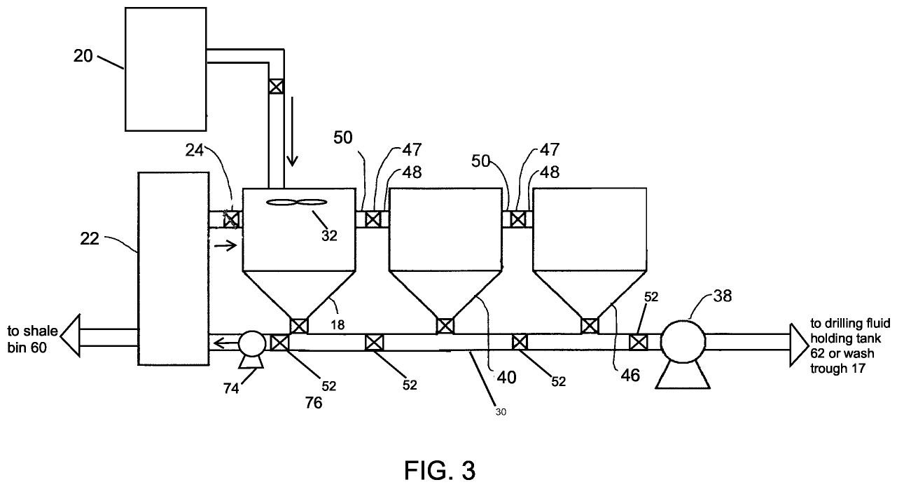

As illustrated in FIGS. 2 and 3, but not in FIG. 1, the separated fluids from the centrifuges 20 and 22 respectively may be returned to separator tanks 12 and 18 at any convenient height and controlled by valve 24.

Referring to FIGS. 2 and 3, first and second separator tanks 12 and 18 include a mechanical agitator 32 that causes the liquid hydrocarbons present in the drilling fluid to foam and hence separate from the drilling fluid. This method works with drilling fluids that generally do not foam.

Down stream of first and second separator tanks 12 and 18 are one or more settling tanks. As shown, preferably there are two sets of two settling tanks 40 and 42 in series with first separator tank 12 and settling tanks 44 and 46 connected in series in relation with second separator tank 18. Each settling tank has an inlet 48 that receives the used drilling fluid from the next tank upstream. Tanks 40 and 42 each also have an outlet 50 that outputs the used drilling fluid to the next settling tank. Settling prevents foamed liquid hydrocarbons from passing through outlet 50, and allows foam to instead be skimmed from the top of each tank. More preferably foam can be extracted by a vacuum line from a top surface of each of tanks 12, 18, 40, 42, 44 and 46.

Settling tanks 44 and 46 are not connected to another downstream tank. Each settling tank 40, 42, 44 and 46 is also connected to line 30 near a bottom of each tank, for example as shown in FIGS. 2 and 3. Line 30 is connected to pumps 74 and 76, taking solids to centrifuges 20 and 22, and also to a high volume pump 38, such as a Mission™ pump. Valving 52 between each of the separator tanks 12/18 and the settling tanks 42/44/40/46 allows for flexibility in where the contents of the tanks are sent. The decision on whether tank contents are sent to centrifuge 20/22 or to drilling fluid storage/reuse can be based on, for example, the solids content at the bottom of each tank. In a preferred embodiment of an arrangement of valves, the contents of separator tanks 20/22 and settling tanks 40 and 42 often have sufficient solids content and are sent to centrifuges 20/22, whereas settling tanks 44 and 46 have very little to no solids content and are therefore sent to pump 38.

Pump 38 may have an outlet 56 to capture the separated drilling fluid to be stored in a drilling fluid holding tank 62 and used to replenish the drilling fluid being used in the drilling operation, or to provide relatively clean fluid via line 58 to wash the rig shaker 19 and prevent a build-up of cuttings in its collection trough.

Between operations, line 30 together with pump 38 can be used to flush out the entire separator 10 system. In such cases, valves 52 just upstream of pumps 74 and 76 are closed and all other valves 52 are opened to allow fluid from separator and settling tanks to be pumped empty by pump 38 and then valves at the lower end of each tank can be closed and the tanks filled at least in part with a base fluid.

Preferably, settling tanks 40, 42, 44 and 46 are designed such that there is a minimal amount of disturbance to allow solids to settle.

Referring to FIGS. 1, 2 and 3, valves 24 directs flow of drilling fluid from centrifuges 20 and 22 to separator tanks 12 and 18 and while a series of valves 47 are provided that allow the flow of drilling fluid to be directed between separator and settling tanks. Valves 47 control the flow between tanks, and valves 52 control what tanks are drawn upon by pump 38 or pumps 74/76, depending on solids content. For example, by selectively opening and closing certain valves 52, pump 38 may be used to draw fluid from settling tank 42 instead of tank 44 or 46. Alternatively, centrifuge 20 may draw fluid from tank 42 rather than tank 12. Centrifuge 20 is used to remove solids from the system as it draws from separator tank 12, and then circulates the drilling fluid through the system via separator tank 12 and settling tanks 42 and 44. It will be understood that the actual configuration of lines and valves may vary depending on the preferences of the user.

Referring to FIG. 1, before receiving the drilling fluids, the various tanks in separator 10 are filled with a base fluid that is substantially the same as the drilling fluid, the used drilling fluid being deposited into the base fluid. The tanks may not be entirely filled to leave sufficient room for the anticipated volume of drilling fluids.

As mentioned above, paddles 32 are used to agitate fluid in separator tanks 12 and 18, although other types of agitators may also be used. As depicted, fluids are circulated through separator 10 to be treated continuously. An injection port 54 allows flocculants to be injected into the system via line 36. The flocculant encourages the fine particles in the cuttings to be agglomerate, making them easier to remove. Captured solids or cuttings from screen 15 can also be output into a waste stream such as shale bin 60.

In a preferred embodiment, six tanks are used—two separator tanks 12 and 18 and four settling tanks 40, 42, 44 and 46. As shown, each tank is connected to the other adjacent tanks in series. By controlling the flow between inlets and outlets with valves or gates 47, the flow path through separator 10 may be changed.

Additionally, a heater system 64 may be fluidly connected to the separator tanks 12 and 18 via either the injection line 36, or by separate lines (not shown) to heat fluid in the system to help separate hydrocarbons from the solids. Valves 66 and 68 may be operated to control the fluid connection between line 36, the heater system 64, and chemical tank 54. Ideally, the heater system 64 is capable of heating 30 cubic meters of fluid to 70 degrees Celsius within a few hours and maintain that temperature in minus 50 degrees Celsius ambient temperature.

Operation:

In operation, drill cuttings or solids are introduced into separator tank 12 where they are agitated by agitator 32 and heated with heated water by a flow through the line 36 by pump 70 to separate hydrocarbons from the solids. As the fluid flows from tank 12 to tank 18, the solids settle to the bottom of the tanks, where they are drawn by pumps 74 and 76 and fed to centrifuges 20 and 22.

Separator 10 is intended to be used at a drilling site. Accordingly, it is preferably skid-mounted for ease of transport. Referring to FIG. 1, each tank 12, 18, 40, 42, 44, and 46 are initially filled with a base fluid that is the same, or substantially the same, as the drilling fluid used in the drilling operation. Referring to FIGS. 1, 2 and 3, valves 47 and 52 are set to handle the anticipated load. The slurry of drilling fluid, oil and cuttings are deposited from the rig shaker 19 into the base fluid in first separator tank 12. The mixture is agitated by agitator 32 to cause the oil to foam. At the same time, first centrifuge 20 draws fluid out of first separator tank 12 through via pump 74 to remove solids from the fluid, and returns the fluid to tank 12. Solids from centrifuge 20 are then transported to either shale bin 60 or second separator tank 18, where second centrifuge 22 removes more solids from the fluid. In this way, the series of the first separator tank 12 and first centrifuge 20 serve to remove the majority of hydrocarbons and drilling fluids from the solids. The second separator tank 18 and second centrifuge 22 serve to remove further hydrocarbons and drilling fluid from the solids. This leads to a dry, saleable sand product that is virtually hydro-carbon and drilling fluid. The present inventors have found that the solids product exiting second centrifuge 22 can be used for among other purposes, as playground sand.

From first separator tank 12, fluid moves through settling tanks 42 and 44 and fluid also moves from second separator tank 18 to settling tanks 40 and 46 as each respective upstream tank overflows into the next downstream tank. As discussed above, the actual flow path through the various tanks may be changed by selectively opening and closing gates 47. In each settling tank 40, 42 and 44, the foamed oil will float to the top, while the solids settle to the bottom. Generally, the heavier solids will be removed by centrifuges, while settling tanks 40, 42, and 44 target the fines. The settling solids fall toward the sloped bottom, where they are removed by having centrifuge 20 or 22 draw from that tank. Fluids from each settling tank move on to the next settling tank. From settling tank 46 and also tank 44, the fluid is drawn off through outlet 56 to replace drilling fluid used in the drilling operation and to wash out the rig shaker. The process is therefore a continuous process that is driven by the newly deposited used drilling fluids, while diluting those drilling fluids in the base fluid and the separated fluid.

Cuttings removed by centrifuges 20 and 22 are more cleaner, drier and more easily disposed of relative to traditional methods as they are now a saleable sand product, useable for example as playground sand. At the same time, since drilling fluid is recovered by the process, it reduces the amount of new drilling fluid that needs to be introduced into the drilling operation.

It may be that second separator 18, second centrifuge 22 and second series of settling tanks 40 and 46 are not required for full removal of hydrocarbons from the drilling solids and solids are merely collected from first centrifuge 20 into shale bin 60. In such cases, the second separator tank 18, second centrifuge 22, and settling tanks 40 and 46 can be connected to a drill rig's active system to clean drilling mud before deployment downhole. This process, sometimes known as mud polishing, serves to remove ultrafine particles from the mud before it is used in the drilling process.

In this document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A separator for removing hydrocarbons and fluid from solids from a slurry, the separator comprising:
a. a first separator tank for receiving a slurry of fluid and solids contaminated with hydrocarbons, said first separator tank comprising agitating means for agitating hydrocarbons to separate from the slurry and rise as a foam, and comprising a lower end to collect the solids;
b. a first centrifuge in communication with the lower end of the first separator tank to receive and centrifuge the solids to further remove hydrocarbons therefrom, said first centrifuge comprising a solids outlet, and a fluid return to return fluids to the first separator tank;
c. a second separator tank for receiving solids from the first centrifuge, said second separator tank comprising agitator means for agitating hydrocarbons to separate from the slurry and rise as a foam, and comprising a lower end to collect solids;
d. a second centrifuge in communication with the lower end of the second separator tank to receive and centrifuge the solids to further remove hydrocarbons therefrom, said second centrifuge comprising a solids outlet, and a fluid return to return fluids to the second separator tank; and
e. one or more settling tanks connected in series with each of said first and second separator tanks for further separation of hydrocarbons from fluid;
wherein, solids exiting the solids outlets of the first and second centrifuges are at least 99% free of hydrocarbons.

2. The separator of claim 1, wherein the first separator tank comprises a slurry inlet in the form of a screen.

3. The separator of claim 2, wherein the screen is fed slurry from a trough connected to a rig shaker.

4. The separator of claim 1, wherein the agitator means comprise paddles.

5. The separator of claim 1, comprising two settling tanks connected in series with each of the first separator tank and the second separator tank 18.

6. The separator of claim 1, further comprising a vacuum line for extracting foam from a top surface of each of separator tank and each settling tank.

7. The separator of claim 1, wherein the first and second separator tanks and the settling tanks are connected to line, said line connected at a first end to said first and second centrifuges and connected at a second end to a fluid holding tank.

8. The separator of claim 7, further comprising one or more valves on the line for directing fluid to one or more of either the first and second centrifuges or to the fluid holding tank.

9. The separator of claim 1, further comprising an injection port in communication with each of said first and second separator tanks, for injection of flocculants.

10. The separator of claim 1, further comprising a heater system in fluid communication with the first and second separator tanks to heat the slurry to enhance separation of hydrocarbons from the solids.

11. A method for removing hydrocarbons and fluid from solids from a slurry, the method comprising the steps of:
a. receiving a slurry of fluid and solids contaminated with hydrocarbons a first separator tank, agitating the slurry to separate hydrocarbons from the slurry to rise as foam and allowing solids to settle;
b. receiving solids in a first centrifuge from a lower end of the first separator tank and centrifuging the solids to further remove hydrocarbons therefrom;
c. receiving solids from the first centrifuge into a second separator tank and agitating the solids to separate hydrocarbons from the slurry to rise as foam and allowing solids to settle;
d. receiving solids in a second centrifuge from a lower end of the second separator tank to receive and centrifuge the solids to further remove hydrocarbons therefrom; and
e. transferring fluids from first and second separator tanks into one or more settling tanks connected in series to separate hydrocarbons from the fluid;
wherein, solids exiting the first and second centrifuges are at least 99% free of hydrocarbons.

12. The method of claim 11, further comprising passing the slurry through a screen before receiving the slurry in the first separator tank.

13. The method of claim 11, further comprising heating the contents of the first and second agitator to enhance separation of hydrocarbons from the solids.

14. The method of claim 11, further comprising extracting foam from a top surface of each of separator tank and each settling tank via a vacuum line.

15. The method of claim 11, further comprising directing the contents of the lower end of each of the first and second separator tanks and a lower end of each of the settling tanks to any of said first and second centrifuges and to a fluid holding tank.

16. The method of claim 1, further comprising injecting flocculants into each of said first and second separator tanks.
